(19) United States
(12) Patent Application Publication
(10) Pub. No.: US 2007/0016497 A1
(43) Pub. Date: Jan. 18, 2007

(54) Financial indexes and instruments based thereon

(76) Inventors: Catherine T. Shalen, Chicago, IL (US); William M. Speth, Evanston, IL (US)

Correspondence Address: Paul E Schaafsma;NovusIP, LLC, Suite 221, 521 West Superior Street, Chicago, IL, 60610, US

(21) Appl. No.: 11/180,213

(22) Filed: Jul. 13, 2005

(51) Int. Cl. G06Q 40/00

(52) U.S. Cl. 705/35

(57) ABSTRACT

In accordance with the principles of the present invention, various financial instruments are provided. In one embodiment, a financial instrument measures the performance of a covered call strategy by selling out-of-the-money call options on an underlying asset. In another embodiment, a financial instrument measures the total return of a put protected strategy on an underlying asset. In another embodiment, a financial instrument measures the total return of a collar strategy on an underlying asset.

### FIELD OF THE INVENTION

The present invention relates to financial indexes and financial instruments related thereto.

### BACKGROUND OF THE INVENTION

Hedging can be defined as the purchase or sale of a security or derivative (such as options or futures and the like) in order to reduce or neutralize all or some portion of the risk of holding another security or other underlying asset. Hedging equities is an investment approach that can alter the payoff profile of an equity investment through the purchase and/or sale of options or other derivatives. Hedged equities are usually structured in ways that mitigate the downside risk of an equity position, albeit at the cost of some of the upside potential.

An option can be defined as a contract between two parties in which one party has the right but not the obligation to do something, usually to buy or sell some underlying asset at a given price, called the exercise price, on or before some given date. Options have been traded on the SEC-regulated Chicago Board Options Exchange, 400 South LaSalle Street, Chicago, Ill. 60605 (“CBOE”) since 1973. Call options are contracts giving the option holder the right to buy something, while put options, conversely entitle the holder to sell something. A covered call option is a call option that is written against the appropriate opposing position in the underlying security (such as, for example, a stock or a basket of stocks and the like) or other asset (such as, for example, an exchange traded fund or future and the like). A protective put is a put option that is purchased against the appropriate opposing position in the underlying asset. A collar is an options strategy that combines put options and call options to limit, but not eliminate, the risk that their value will decrease.

One drawback of utilizing these trading strategies is that no suitable benchmark index has existed against which a particular portfolio manager's performance could be measured. For example, even those who understand a trading strategy may not have the resources to see how well a particular implementation of the strategy has performed in the past. Thus, what is needed is an investible index for which real financial instruments based on the functionality of the index can be created and actively traded.

In addition, a key attribute to the success of any index is its perceived integrity. Integrity, in turn, is based on a sense of fairness. For the market to perceive an index to be a “fair” benchmark of performance, the rules governing index construction must be objective and transparent. Also, it would be advantageous for the index to strike an appropriate balance between the transaction costs for unduly short-term options and the lack of premiums received from unduly long-term options. Also, it would be advantageous for the index to represent an executable trading strategy as opposed to a theoretical measure. Still further, it would be advantageous for the index to be updated and disseminated on a daily basis.

What is thus needed is a financial instrument that provides the investment community with a benchmark for measuring the performance of a portfolio consisting of an underlying asset and options on that underlying asset. Such financial instrument must be objective and transparent.

### SUMMARY OF THE INVENTION

A financial instrument in accordance with the principles of the present invention provides the investment community with an opportunity to measure option buy-write performance. A financial instrument in accordance with the present invention is objective and transparent. In one embodiment, a financial instrument in accordance with the present invention measures the performance of a covered call strategy by selling out-of-the-money call options on an underlying asset. In another embodiment, a financial instrument in accordance with the present invention measures the total return of a put protected strategy on an underlying asset. In another embodiment, a financial instrument in accordance with the present invention measures the total return of a collar strategy on an underlying asset.

### DETAILED DESCRIPTION OF THE PREFERRED EMBODIMENTS

In accordance with the principles of the present invention, a series of financial instruments are created that establish benchmark indexes against which a particular portfolio manager's performance can be measured. As known in the art, an index in accordance with the principals of the present invention can be preferably embodied as a system cooperating with computer hardware components, and as a computer-implemented method.

### Example 1

### Covered Call Index

In accordance with the principles of the present invention, an index was designed to measure the performance of a covered call out-of-the-money strategy. This index consists of holding a stock index portfolio and selling a succession of one-month 5% out-of-the-money call options on the stock index. Each call can be generally held to the open of the third Friday of the month, and a new 5% out-of-the-money call expiring in the next month can be then sold, a procedure referred to as “rolling the call”. This index can be a chained index, calculated daily at the close as 100 times the cumulative product of gross daily returns of this covered call strategy since the inception date of the index.

On all but roll dates, the gross daily return of this index can be calculated from the close-to-close change in the value of the covered stock index portfolio plus the aggregate value of dividends distributed by index component stocks on that date. On roll dates, the gross daily return can be compounded from: the return from the previous close to 11:00 a.m. (Eastern Time), after the final settlement of the expiring call; the return from 11:00 a.m. to 12:00 p.m. (Eastern Time) when the CBOE completes the calculation of half-hour volume-weighted prices for both the price of the new call sold and the stock index; and the return from 12:00 p.m. (Eastern Time) to the close of trading.

The calculation used to generate a historical series of this index differs slightly from the procedure above because historical intra-day volume data are not available. The index can be calculated once per day at the close of trading. On any given day, the index (CCI) can be calculated as follows:
CCIₜ=CCIₜ₋₁(1+Rₜ)
where Rₜ is the daily rate of return of the covered stock index portfolio. This rate includes ordinary cash dividends paid on the component stocks of the stock index that trade “ex-dividend” on that date.

On each trading day excluding roll dates, the daily gross rate of return of the CCI index equals the change in the value of the components of the covered stock index portfolio, including the value of ordinary cash dividends payable on component stocks in the index that trade “ex-dividend” on that date, as measured from the close in trading on the preceding trading day. The gross daily rate of return is equal to:
1+Rₜ=(Sₜ+Divₜ−Cₜ)/(Sₜ₋₁Cₜ₋₁)
where Sₜ is the closing value of the stock index at date t; Sₜ₋₁ is the closing value of the stock index on the preceding trading day; Divₜ represents the ordinary cash dividends payable on the component stocks of the index that trade “ex-dividend” at date t expressed in index points; Cₜ is the arithmetic average of the last bid and ask prices of the call option reported before 4:00 p.m. (Eastern Time) at date t; and Cₜ₋₁ is the average of the last bid and ask prices of the call option reported before 4:00 p.m. (Eastern Time) on the preceding trading day.

On roll dates, the gross daily rate of return can be compounded from: the gross rate of return from the previous close to 11:00 a.m. (Eastern Time) after the determination of the Special Opening Quotation of the S&P 500° index to which the expiring call is settled; the gross rate of return from 11:00 a.m. to 12:00 p.m. (Eastern Time) when the new call option is deemed sold at the volume-weighted average price (VWAP) determined between 11:30 a.m. and 12:00 p.m. (Eastern Time); and the gross rate of return from 12:00 p.m. (Eastern Time) to the close of trading, expressed as follows:
1+Rₜ=(1+Rₐ)×(1+R_{b})×(1+R_{c})
where:
1+Rₐ=(S^{SOQ}+Divₜ−C_{Settle})/(Sₜ₋₁Cₜ₋₁);
1+R_{b}=(S^{VWAP})/(S^{SOQ});
and
1+R_{c}=(Sₜ−Cₜ)/(S^{VWAP}−C_{VWAP})
and where Rₐ is the rate of return of the covered stock index portfolio from the previous close of trading through 11:00 a.m. (Eastern Time); R_{b} is the rate of return of the un-covered stock index portfolio from 11:00 a.m. to 12:00 p.m. (Eastern Time); R_{c} is the rate of return of the covered stock index portfolio from 12:00 p.m. (Eastern Time) to the close of trading on the roll date; S^{SOQ} is the Special Opening Quotation of the S&P 500®0 index; S^{VWAV} is the VWAP of the stock index based on the same time and weights used to calculate the VWAP in the new call option; C_{VWAV} is the volume-weighted average trading price of the new call option; and Cₜ refers to the average bid/ask quote of the new call option reported before 4:00 p.m. (Eastern Time) on the roll date. The Special Opening Quotation is generally based on the opening values of the component stocks, regardless of when those stocks open on expiration day. As previously defined, Divₜ represents dividends on index component stocks determined in the same manner as on non-roll dates, and C_{Settle} is the final settlement price of the expiring call option (C_{Settle}=Max [0, SOQ−K], where K is the strike price.) Sₜ₋₁ and Cₜ₋₁ are determined in the same manner as on non-roll dates.

For the historical series, the gross daily return on roll dates can be calculated as
1+Rₜ=(1+Rₐ)×(1+R_{b})
where:
1+Rₐ=(S₁₁+Divₜ−C_{Settle})/(Sₜ₋₁−Cₜ₋₁);
and
1+R_{b}=(Sₜ−Cₜ)/(S₁₁−C₁₁^{bid})
and where S₁₁ is the last price of the index quoted before 11:00 a.m. (Eastern Time), and C^{bid}₁₁ is the last bid price of the new call option quoted before 11:00 a.m. (Eastern Time). The price of the stock index and index dividends are obtained from Bloomberg L.P., 499 Park Avenue, New York, N.Y. Index option prices are obtained from CBOE's time and sales data which are publicly disseminated through the Option Price Reporting Authority, 400 South LaSalle Street, Chicago, Ill. 60605.

In the previous examples, the example indexes in accordance with the principles of the present invention measured the performance of a covered call strategy. In accordance with further embodiments of the present invention, additional indexes were designed to measure the performance of various strategies.

### Example 2

### Put Protected Index

In accordance with a further embodiment in accordance with the present invention, an index was designed to measure the total return of a put protected strategy. This strategy consists of holding a stock index portfolio and buying a succession of one-month at-the-money put options on this stock index. Each put can be generally held to the open of the third Friday of the month, and a new at-the-money put expiring in the next month can be then bought, a procedure referred to as “rolling the put”. This index can be a chained index, calculated daily at the close as 100 times the cumulative product of gross daily returns of this put protected strategy since the inception date of the index.

On all but roll dates, the gross daily return of this index can be calculated from the close-to-close change in the value of the put protected stock index portfolio plus the aggregate value of dividends distributed by index component stocks fund on that date. On roll dates, the gross daily return can be compounded from: the return from the previous close to 11:00 a.m. (Eastern Time), after the final settlement of the expiring put; the return from 11:00 a.m. (Eastern Time) to 12:00 a.m. (Eastern Time) when the CBOE completes the calculation of half-hour volume-weighted prices for both the price of the new put bought and the stock index; and the return from 12:00 a.m. to the close of trading. The calculation used to generate a historical series of this index differs slightly from the procedure above because historical intra-day volume data are not available.

The index can be calculated once per day at the close of trading. On any given day, the index (PP) can be calculated as follows:
PPₜ=PPₜ₋₁(1+Rₜ)
where Rₜ is the daily rate of return of the put protected stock index portfolio. This rate includes ordinary cash dividends paid on the component stocks of the stock index that trade “ex-dividend” on that date.

On each trading day excluding roll dates, the daily gross rate of return of the index equals the change in the value of the components of the covered stock index portfolio, including the value of ordinary cash dividends payable on component stocks in this index that trade “ex-dividend” on that date, as measured from the close in trading on the preceding trading day. The gross daily rate of return can be equal to:
1+Rₜ=(Sₜ+Divₜ+Pₜ)/(Sₜ₋₁+Pₜ₋₁)
where Sₜ is the closing value of the stock index at date t; Sₜ₋₁ is the closing value of the stock index on the preceding trading day; Divₜ represents the ordinary cash dividends payable on the component stocks of the index that trade “ex-ividend” at date t expressed in index points; Pₜ is the arithmetic average of the last bid and ask prices of the put option reported before 4:00 p.m. (Eastern Time) at date t; and Pₜ₋₁ is the average of the last bid and ask prices of the put option reported before 4:00 p.m. (Eastern Time) on the preceding trading day.

On roll dates, the gross daily rate of return can be compounded from: the gross rate of return from the previous close to 11:00 a.m. (Eastern Time) after the Special Opening Quotation is determined and the expiring put is settled; the gross rate of return from 11:00 a.m. to 12:00 a.m. when the new put is deemed bought at the volume-weighted average price (VWAP) determined between 11:30 a.m. and 12:00 p.m. (Eastern Time); and the gross rate of return from 12:00 a.m. (Eastern Time) to the close of trading on the roll date, expressed as follows:
1+Rₜ=(1+Rₐ)×(1+R_{b})×(1+R_{c})
where:
1+Rₐ=(S^{SOQ}+Divₜ+P_{Settle})/(Sₜ₋₁+Pₜ₋₁);
1+R_{b}=(S^{VWAP})/(S^{SOQ});
and
1+R_{c}=(Sₜ+Pₜ)/(S^{VWAP}+P_{VWAP})
and where Rₐ is the rate of return of the put protected stock index portfolio from the previous close of trading through the settlement of the expiring put option; R_{b} is the rate of return of the non-protected stock index portfolio from the settlement of the expiring option to the time the new put option is deemed bought; R_{c} is the rate of return of the covered stock index portfolio from the time the new call option is deemed sold to the close of trading on the roll date; S^{SOQ} is the Special Opening Quotation used in determining the settlement price of the expiring put option; S^{VWAV} is the VWAP of the stock index based on the same time and weights used to calculate the VWAP of the new put option; P_{VWAV} is the volume-weighted average trading price of the new put option between 11:30 a.m. and 12:00 p.m. (Eastern Time); and Cₜ refers to the average bid/ask quote of the new put option reported before 4:00 p.m. (Eastern Time) on the roll date. As previously defined, Divₜ represents dividends on index component stocks determined in the same manner as on non-roll dates, and P_{Settle} is the final settlement price of the expiring put option (P_{Settle}=Max [0, K−SOQ], where K is the strike price.) Sₜ₋₁ and Cₜ₋₁ are determined in the same manner as on non-roll dates.

For the historical series, the gross daily return on roll dates can be calculated as:
1+Rₜ=(1+Rₐ)×(1+R_{b})
where:
1+Rₐ=(S₁₁+Divₜ+Pₛₑₜₜₗₑ)/(Sₜ₋₁+Pₜ₋₁)
and
1+R_{b}=(Sₜ+Pₜ)/(S₁₁+P₁₁^{ask})
and where S₁₁ is the last price of the index quoted before 11:00 a.m., and P^{ask}₁₁ is the last ask price of the new put option quoted before 11:00 a.m. The price of the stock index and index dividends are obtained from Bloomberg, index option prices are obtained from CBOE's time and sales data which are publicly disseminated through the Option Price Reporting Authority.

### Example 3

### Collar Index

In accordance with a further embodiment in accordance with the present invention, an index was designed to measure the total return of a collar strategy. This strategy consists of holding a stock index portfolio, buying a succession of one-month 5% out-of-the-money put options on this stock index, while also selling a succession of one-month 5% out-of-the-money call options on the stock index. The put and call are generally held to the open of the third Friday of the month, and a new 5% out-of-the-money put as well as a new 5% out-of-the-money call expiring in the next month are bought and sold respectively, a procedure referred to as “rolling the collar”. This index can be a chained index, calculated daily at the close as 100 times the cumulative product of gross daily returns of this put protected strategy since the inception date of the index.

On all but roll dates, the gross daily return of the index can be calculated from the close-to-close change in the value of the collar index portfolio plus the aggregate value of dividends distributed by index component stocks on that date. On roll dates, the gross daily return can be compounded from: the return from the previous close to 11:00 a.m. (Eastern Time), after the final settlement of the expiring put and call; the return from 11:00 a.m. to 12:00 p.m. (Eastern Time) when the CBOE completes the calculation of half-hour volume-weighted prices of the new put and call and of the stock index; and the return from 12:00 p.m. (Eastern Time) to the close of trading. The calculation used to generate a historical series of this index differs slightly from the procedure above because historical intra-day volume data are not available.

The index can be calculated once per day at the close of trading. On any given day, the index (PC) can be calculated as follows:
PCₜ=PCₜ₋₁(1+Rₜ)
where Rₜ is the daily rate of return of the collared stock index portfolio. This rate includes ordinary cash dividends paid on the component stocks of the stock index that trade “ex-dividend” on that date.

On each trading day excluding roll dates, the daily gross rate of return of the index equals the change in the value of the components of the collared stock index portfolio, including the value of ordinary cash dividends payable on component stocks in this index that trade “ex-dividend” on that date, as measured from the close in trading on the preceding trading day. The gross daily rate of return can be equal to:
1+Rₜ=(Sₜ+Divₜ+Pₜ−Cₜ)/(Sₜ₋₁+Pₜ₋₁−Cₜ₋₁)
where Sₜ is the closing value of the stock index at date t; Sₜ₋₁ is the closing value of the stock index on the preceding trading day and Pₜ₋₁; Divₜ represents the ordinary cash dividends payable on the component stocks of the index that trade “ex-dividend” at date t expressed in index points; Pₜ and Cₜ are the arithmetic averages of the last bid and ask prices of the put and call options reported before 4:00 p.m. (Eastern Time) at date t; and Cₜ₋₁ are the averages of the last bid and ask prices of the put and call options reported before 4:00 p.m. (Eastern Time) on the preceding trading day.

On roll dates, the gross daily rate of return can be compounded from: the gross rate of return from the previous close to 11:00 a.m. (Eastern Time) after the determination of the Special Opening Quotation of the S&P 500® index to which the expiring put and call are settled; the gross rate of return from 11:00 a.m. to 12:00 p.m. (Eastern Time) when the new put and call positions are deemed bought and sold respectively at the volume-weighted average prices (VWAP) determined between 11:30 a.m. and 12:00 p.m. (Eastern Time); and the gross rate of return from 12:00 p.m. (Eastern Time) to the close of trading on the roll date, expressed as follows:
1+Rₜ=(1+Rₐ)×(1+R_{b})×(1+R_{c})
where:
1+Rₐ=(S^{SOQ}+Divₜ+P_{Settle} −Cₛₑₜₜₗₑ)/(Sₜ₋₁+Pₜ₋₁−Cₜ₋₁);
1+R_{b}=(S^{VWAP})/(S^{SOQ});
and
1+R_{c}=(Sₜ+Pₜ−Cₜ)/(S^{VWAP}+P_{VWAP}−C_{VWAP})
and where Rₐ is the rate of return of the collared stock index portfolio from the previous close of trading to 11:00 a.m. (Eastern Time); R_{b} is the rate of return of the stock index portfolio from the settlement of the expiring option to the time the new put and call options are deemed bought and sold; R_{c} is the rate of return of the collared stock index portfolio from the time the new put and call options are deemed bought and sold to the close of trading on the roll date; S^{SOQ} is the Special Opening Quotation of the S&P 500® index; S^{VWAV} is the volume-weighted average value of the stock index based on the same time and weights used to calculate the VWAP of the new call and put options; P_{VWAV} and C_{vwav} are the VWAPs of the new put and call options between 11:30 a.m. and 12:00 p.m.; (Eastern Time); and Pₜ and Cₜ refers to the average bid/ask quote of the new put and call options reported before 4:00 p.m. (Eastern Time) on the roll date. As previously defined, Divₜ represents dividends on index component stocks determined in the same manner as on non-roll dates, and Pₛₑₜₜₗₑ and C_{Settle} are the final settlement prices of the expiring put and call options (P_{Settle}=Max [0, K−SOQ], and Cₛₑₜₜₗₑ=Max [0,SOQ−K] where K is the strike price). Sₜ₋₁, Pₜ₋₁ and Cₜ₋₁ are determined in the same manner as on non-roll dates. As defined above, S^{VWAV} is the volume-weighted average value of the stock index based on the combined times and volumes used to calculate the VWAP of the new put and call options.

For the historical series, the gross daily return on roll dates can be calculated as
1+Rₜ=(1+Rₐ)×(1+R_{b})
where:
1+Rₐ=(S₁₁+Divₜ+P_{Settle}−C_{Settle})/(Sₜ₋₁+Pₜ₋₁Cₜ₋₁);
and
1+R_{b}=(Sₜ+Pₜ−Cₜ)/(S₁₀+P₁₁^{ask}−C₁₁^{bid})
and where S₁₁ is the last price of the index quoted before 11:00 a.m. (Eastern Time).; p^{ask}₁₁ is the last ask price of the new put option; and C^{bid}₁₁ is the last bid price of the new call option quoted before 11:00 a.m. (Eastern Time). The price of the stock index and index dividends are obtained from Bloomberg, index option prices are obtained from CBOE's time and sales data which are publicly disseminated through the Option Price Reporting Authority.

It should be understood that various changes and modifications preferred in to the embodiment described herein would be apparent to those skilled in the art. For example, additional financial instruments based on the financial instruments of the present invention such as exchange traded funds are to be considered within the scope of the present invention. Such changes and modifications can be made without departing from the spirit and scope of the present invention and without demising its attendant advantages. It is therefore intended that such changes and modifications be covered by the appended claims.

What is claimed is:

1. A financial instrument comprising measuring the performance of a covered call strategy by selling out-of-the-money call options on an underlying asset.

2. The financial instrument of claim 1 further including holding a stock index portfolio and selling a succession of out-of-the-money call options on the stock index.

3. The financial instrument of claim 2 further wherein the out-of-the-money call options comprise one-month out-of-the-money call options.

4. The financial instrument of claim 2 further wherein the out-of-the-money call options comprise 5% out-of-the-money call options.

5. The financial instrument of claim 1 further including rolling the call.

6. The financial instrument of claim 1 further including calculating the financial instrument (CCI) in accordance with:
CCIₜ=CCIₜ₋₁(1+Rₜ)
where Rₜ is the daily rate of return of the portfolio.

7. The financial instrument of claim 1 further wherein the financial instrument is an index.

8. The financial instrument of claim 1 further wherein the financial instrument is an exchange traded fund.

9. The financial instrument of claim 1 further including leveraging the financial instrument by adjusting to the desired level of risk the proportions of a long position in the underlying asset and a short position in the call options for that asset.

10. A financial instrument comprising a measure of the total return of a put protected strategy on an underlying asset.

11. The financial instrument of claim 10 further including measuring the performance of a stock index portfolio protected by puts on the index.

12. The financial instrument of claim 10 further including holding a stock index portfolio and buying a succession of put options on this stock index.

13. The financial instrument of claim 12 further wherein the put options comprise one month put options.

14. The financial instrument of claim 12 further wherein the put options comprise at-the-money put options.

15. The financial instrument of claim 10 further including rolling the put.

16. The financial instrument of claim 10 further including calculating the financial instrument (PP) in accordance with:
PPₜ=PPₜ₋₁(1+Rₜ)
where Rₜ is the daily rate of return of the portfolio.

17. The financial instrument of claim 10 further wherein the financial instrument is an index.

18. The financial instrument of claim 10 further wherein the financial instrument is an exchange traded fund.

19. The financial instrument of claim 10 further including leveraging the financial instrument by adjusting to the desired level of risk the proportions of a long position in the underlying asset and a long position in the put options for that asset.

20. A financial instrument comprising a measure of the total return of a collar strategy on an underlying asset.

21. The financial instrument of claim 20 further including measuring the performance of a stock index portfolio protected by a long put position combined with a short call position on the index.

22. The financial instrument of claim 20 further including holding a stock index portfolio, buying a succession of out-of-the-money put options on this stock index, while also selling a succession of out-of-the-money call options on the stock index.

23. The financial instrument of claim 22 further wherein the out-of-the-money put options comprise 5% out-of-the-money put options.

24. The financial instrument of claim 22 further wherein the out-of-the-money put options comprise one-month out-of-the-money put options.

25. The financial instrument of claim 22 further wherein the out-of-the-money call options comprise 5% out-of-the-money call options on.

26. The financial instrument of claim 22 further wherein the out-of-the-money call options comprise one-month out-of-the-money call options on.

27. The financial instrument of claim 20 further including rolling the collar.

28. The financial instrument of claim 20 further including calculating the financial instrument (PC) in accordance with:
PCₜ=PCₜ₋₁(1+Rₜ)
where Rₜ is the daily rate of return of the portfolio.

29. The financial instrument of claim 20 further wherein the financial instrument is an index.

30. The financial instrument of claim 20 further wherein the financial instrument is an exchange traded fund.

31. The financial instrument of claim 20 further including leveraging the financial instrument by adjusting to the desired level of risk the proportions of a long position in the underlying asset and a short position in the collar for that asset.

32. A financial instrument comprising basing the financial instrument on a return of a portfolio consisting of an underlying asset and options on that underlying asset.

33. The financial instrument of claim 32 further wherein the options are call options

34. The financial instrument of claim 33 further wherein the options are out-of-the-money call options.

35. The financial instrument of claim 33 further wherein the options comprise a succession of out-of-the-money call options.

36. The financial instrument of claim 33 further including valuing the call option at a price equal to the volume-weighted average of the traded prices of the call option.

37. The financial instrument of claim 33 further wherein the call option is cash-settled.

38. The financial instrument of claim 33 wherein the call option comprises a basket of call options.

39. The financial instrument of claim 33 wherein the call option is selected from the group comprising security call options, commodity call options, a stock index call option, and combinations thereof.

40. The financial instrument of claim 33 wherein the call option is selected from the group comprising securities, commodities, indexes, economic indicators, and combinations thereof.

41. The financial instrument of claim 32 wherein the underlying asset is selected from the group comprising stocks, baskets of stocks, stock indexes, exchange-traded finds, exchange-traded futures, and combinations thereof.

42. The financial instrument of claim 32 wherein an underlying asset is selected from the group comprising securities, commodities, indexes, economic indicators, and combinations thereof.

43. The financial instrument of claim 32 wherein the underlying asset portfolio is selected from the group comprising securities, derivatives, commodities, and combinations thereof.

44. The financial instrument of claim 32 further wherein the options are put options.

45. The financial instrument of claim 44 further wherein the options are at-the-money put options.

46. The financial instrument of claim 44 further wherein the options comprise a succession of at-the-money put options.

47. The financial instrument of claim 32 further wherein the options comprise a succession of out-of-the-money put options and a succession of out-of-the-money call options.

48. The financial instrument of claim 32 further wherein the financial instrument is an index.

49. The financial instrument of claim 32 further wherein the financial instrument is an exchange traded fund.

50. The financial instrument of claim 32 further including leveraging the financial instrument by adjusting to the desired level of risk the proportions of a long position in the underlying asset and a short position in the options for that asset.
